(19) United States
(12) Patent Application Publication
(10) Pub. No.: US 2018/0102050 A1
(43) Pub. Date: Apr. 12, 2018

(54) SIGNAL REQUESTING DEVICE

(71) Applicant: CAPTRON Electronic GmbH, Olching (DE)

(72) Inventor: REINHARD BELLM, GERMERING (DE)

(21) Appl. No.: 15/291,708

(22) Filed: Oct. 12, 2016

(51) Int. Cl. G08G 1/07

(52) U.S. Cl. CPC G08G 1/07

(57) ABSTRACT

A signal requesting device for attachment to a pole of a traffic light system. The signal requesting device has a top cover and a housing base, the top cover has an opening for a switch module, an insert ring protruding from the lower side of the top cover, the housing base has an opening with an opening diameter corresponding to the insert ring. A tight fitting of the insert ring within the opening enables simple locking of the top cover by means of a single screw.

### BACKGROUND

### 1. Field of the Invention

The invention relates to a signal requesting device, and, in particular, to a signal requesting device configured for operation of traffic lights.

### 2. Description of Relevant Art

Signal requesting devices are well known, for example from traffic lights at cross walks. U.S. Pat. No. 1,251,666 discloses a municipal traffic-control system. The system has an actuating means comprising a switch which is mounted flush with the roadway, whereby an operator may control the signals while on his feet and pushing a switch. EP 2 270 763 B1 discloses a device for a traffic light, particularly for a pedestrian crossing, comprising a housing, which includes a base housing portion and a cover, a printed circuit board with a switching circuit being arranged in the housing which is connected to a push button or a sensor.

### SUMMARY

The embodiments are based on the object of a vandal proof signal requesting device which may be used in a traffic-control system.

In an embodiment, a signal requesting device comprises a switch module and a housing. The switch module may be configured to detect the presence of an object or a person close to a surface of the switch module, and to generate a trigger signal preferably for a traffic light system. The housing has a top cover and a housing base. The top cover has an outer side and an inner side. The outer side is visible when the top cover is mounted to the housing box. The inner side points towards the housing base and is not visible when the top cover is mounted. The top cover comprises an opening for the switch module, such that the switch module is flush with a surface of the outer side of the top cover. Furthermore, the switch module has a connection terminal for connecting the switch module, preferably to a traffic light system. The connection terminal protrudes from the switch module towards the housing base. In a second embodiment the switch module may be attached to the outer side of the top cover.

The top cover has an insert ring which may protrude from the inner side of the top cover, preferably towards the housing base. The insert ring may have a circular outer contour with an outer surface. Furthermore, the insert ring may have a circumferential groove, preferably at the outer side, which may accommodate a seal to prevent the entry of water or humidity into the housing base. It is preferred, if the seal has a centering effect on the top cover relating to the position to the opening of the housing base. The centered top cover leads to an improved mountability, because a bore of the housing base and the threaded hole in the insert ring are in an aligned position. As a result it is easier to fix the top cover to the housing base via a locking screw.

The housing base further comprises an opening with an opening diameter corresponding to the insert ring, such that the insert ring fits tightly into the opening of the housing base. The opening of the housing base preferably has a circumferential shape preferably with an inner surface.

The insert ring of the top cover and the housing base form a fit system. The fit system is defined by the ratio between a first value and a second value. The first value is defined by the depth of overlapping between the insert ring and the housing base. The second value is defined by the distance of a gap between the insert ring and the inner side of the housing base. The depth of overlapping is defined as the depth, which the insert ring protrudes into the opening of the housing base.

Preferably, the ratio between first value and the second value is larger than 1 most preferably larger than 10. For example, if the first value is 5 mm and the second value is 0.1 mm, the aforementioned ratio is 50. The technical effect of such a fit is, that the top cover cannot be tilted out of the housing base. To open the housing the top cover has to be removed by straight pulling.

In a further embodiment the insert ring has at least one first locking device. The housing base has at least one corresponding second locking device at the inner side of the central opening. The first locking device may comprise a flattening at the outer side of the insert ring preferably at the outer surface. The second locking device may comprise a flattening at the inner side of the central opening, corresponding to the flattening of the first locking device. The second locking device may be designed as a protrusion from the inner surface of the housing base. The first and the second locking device may have any other shape, for example tooth shaped or corrugated. The effect of such a locking device is, that rotation between the top cover and the housing base is prevented. To remove the top cover it has to be pulled out in a linear motion. Diagonally initiated force leads to cant during removing and the top cover cannot be removed.

In a further embodiment multiple first locking devices at the outer side of the insert ring are arranged at 90° to each other. In another embodiment multiple second locking devices at the inner side of the opening of the housing base are arranged at 90° to each other. This allows to place the top cover at multiple angular positions, 90 degree distant from each other, into the housing base. There may be any other angle instead of 90 degrees.

The insert ring may have at least one recess with a threaded hole for holding a locking screw and enabling a mechanical connection between the housing base and the top cover. The housing base has a bore towards the center at the outer side. The bore points towards the center of the housing base and enables the use of a locking screw or locking pin. Thus, the top cover and the housing base are configured to be locked together by a locking screw.

In an alternative embodiment the mechanical connection can be realized with a bayonet connector or a locking pin. Furthermore security screws may be used. A security screw may have a non-standard head. Such a mechanical protection prevents the signal requesting device from the access of not authorized persons.

In an alternative embodiment, an arrow may be provided at the switch module. The arrow indicates the direction respectively the assignment of the requesting device to an explicit traffic light at a crossing which normally corresponds with the chosen direction of movement. It may give visual impaired persons a tactile information about the direction of a crosswalk. In combination with the offset of the multiple first and/or second locking devices different precisely defined mounting options are possible.

The switch module of the signal requesting device preferably has at least one signal device. Each signal device preferably has at least 2 LEDs located adjacent to each other and being controlled by the switch module. The switch module is configured to normally activate a first LED and to switch over to a second LED when the presence of an object or a person is detected. Thus, colorblind persons may realize the change between the LEDs, as the position of the active light source changes. There may be multiple groups of LEDs. The at least one signal device may flush with the surface of the switch module.

The bottom of the mounting base may have at least one fixation hole at the bottom to attach the signal requesting device to a pole of a traffic light system. Furthermore the mounting base may have a curved bottom to fit to the curve of a pole of a traffic light system.

### BRIEF DESCRIPTION OF THE DRAWINGS

In the following, the invention will be described by way of example, without limitation of the general inventive concept, on examples of embodiment and with reference to the drawings.

FIG. 1 shows a first embodiment of the signal requesting device at a pole.

FIG. 2 shows the first embodiment of the signal requesting device.

FIG. 3 shows an exploded drawing of the signal requesting device.

FIG. 4 shows a sectional drawing of the signal requesting device.

FIG. 5 shows another sectional drawing of the signal requesting device.

FIG. 6 shows another sectional drawing of the signal requesting device.

FIG. 7 shows another sectional drawing of the signal requesting device.

FIG. 8 shows a first sectional view.

FIG. 9 shows a second sectional view.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

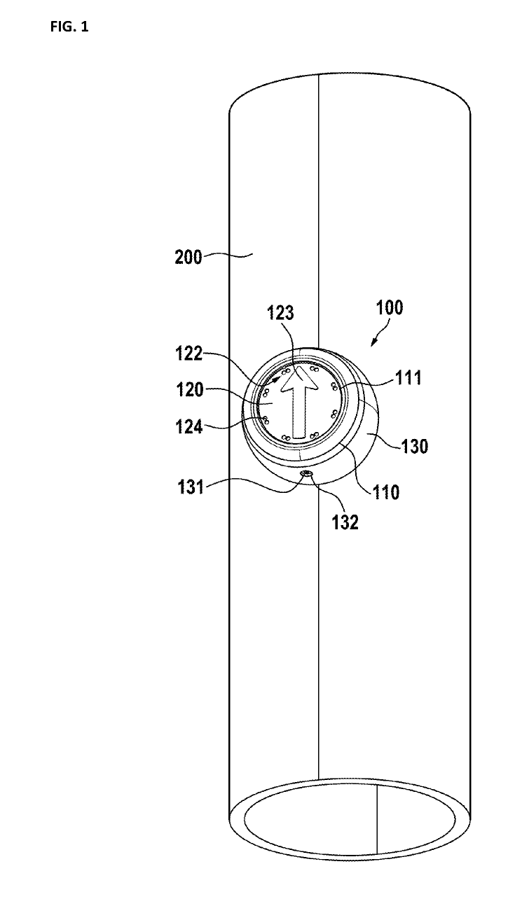

FIG. 1 shows one embodiment of the signal requesting device 100 mounted on a pole 200 of a traffic light system. The signal requesting device 100 has a switch module 120 and a housing 110, 130. The housing has a top cover 110 and a housing base 130. The top cover 110 has an outer side and an inner side. The outer side is visible when the top cover 110 is mounted onto the housing base 130. The inner side points towards the housing base 130. The top cover may comprise an opening 111 for the switch module 120 such that the switch module 120 is flush with the outer side of the top cover 110. In a second embodiment the switch module 120 may be located on the outer side of the top cover 110. The switch module may comprise a contactless sensor switch, e.g. a proximity sensor, which generates a signal, when a person touches or at least comes into close proximity of the switch module.

On the switch module 120 an arrow 123 may be located. The arrow 123 may indicate the direction respectively the assignment of the requesting device 100 to an explicit traffic light at a crossing.

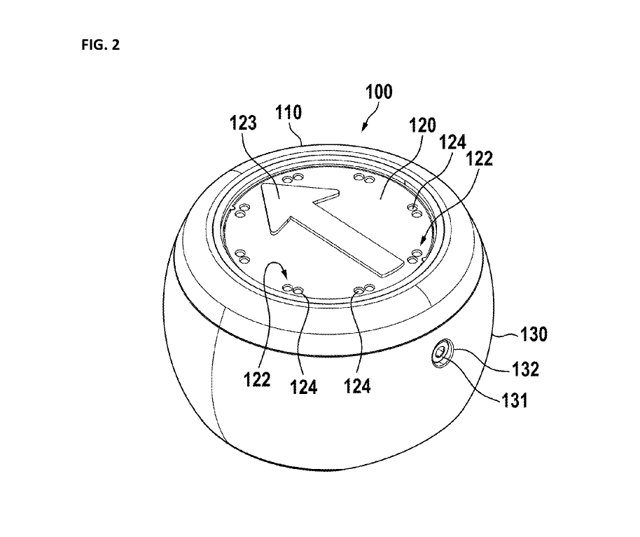

FIG. 2 shows another view of the signal requesting device 100. The signal requesting device 100 has a switch module 120 with at least one signal device 122. The signal device 122 has 2 LEDs 124 located adjacent to each other. The switch module 120 is configured to normally activate a first LED 124, which may be a red LED and to switch over to a second LED 124, which may be a green LED, when the presence of an object or a person is detected. Thus, color-blind persons may realize the change between the LEDs due to a position change of the light source. The colors of the LEDs may also be exchanged. The signal device 122 preferably is flush with the surface of the switch module 120.

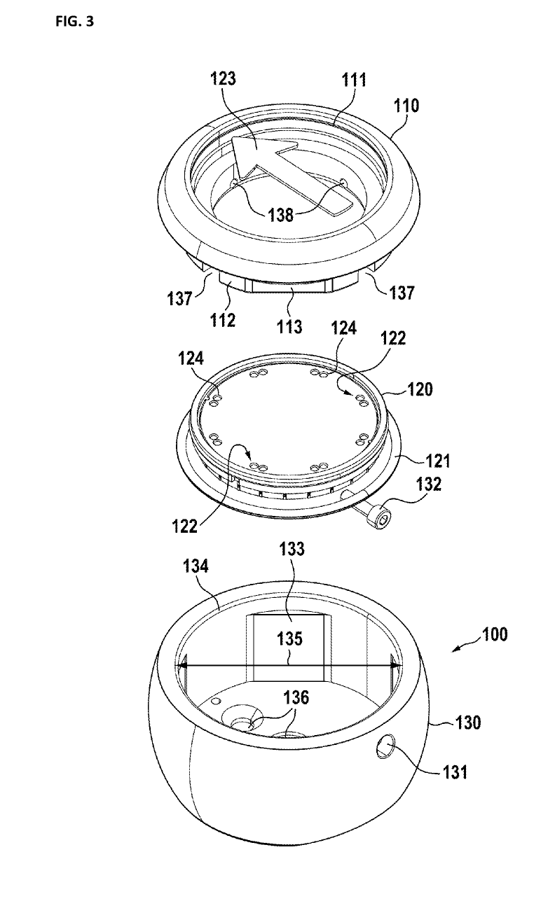

FIG. 3 shows an exploded drawing of the signal requesting device 100. The top cover 110 has an insert ring 112 which may protrude from the inner side of the top cover 110 towards the housing base 130. The insert ring 112 has a circumferential shape and at least one first locking device 113. The first locking device 113 comprises a flattening at the outer surface 140 of the insert ring 112.

The housing base 130 has a circumferential opening 134 with an opening diameter 135 corresponding to the diameter of the insert ring 112. The insert ring 112 and the housing base 130 form a fit system. The opening 134 of the housing base 130 has a circumferential shape. Four second locking devices 133 are arranged with an offset of 90 degrees at the inner surface of the housing base 130. The second locking devices 133 comprise a flattening or recess corresponding to the at least one first locking device 113 at the outer surface 140 of the insert ring 112. The second locking device 133 is designed as a protrusion at the inner surface 139 of the housing base 130. In mounted condition the at least one first locking device 113 engages with the second locking devices 133 such that a rotation of the top cover 110 against the housing base 130 is prevented. Mechanical locking between the top cover 110 and the housing base 130 may be done by a locking screw 132.

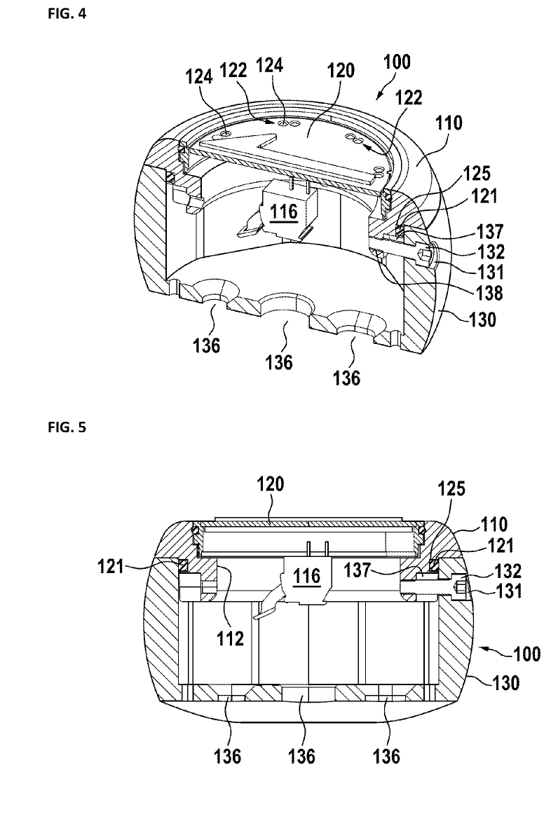

FIG. 4 shows a sectional view of an embodiment. It shows a seal 121 in a circumferential groove 125 around the insert ring 112. The seal 121 prevents the entry of water or humidity. The connection terminal 116 protrudes from the switch module 120. It is an electrical connector from the switch module 120 and the traffic light system. The locking screw 132 prevents an extraction of the top cover 110 from the housing base 130.

The housing base 130 has a bore 131 towards the center at the outer side. It may hold the locking screw 132. The insert ring 112 may have at least one recess 137 with a threaded hole 138 to enable a mechanical connection between the housing base 130 and the top cover 110.

FIG. 5, discloses a signal requesting device 100 with several fixation holes 136. The fixation holes 136 may be used to fix the signal requesting device 100 to a pole 200 of a traffic light system.

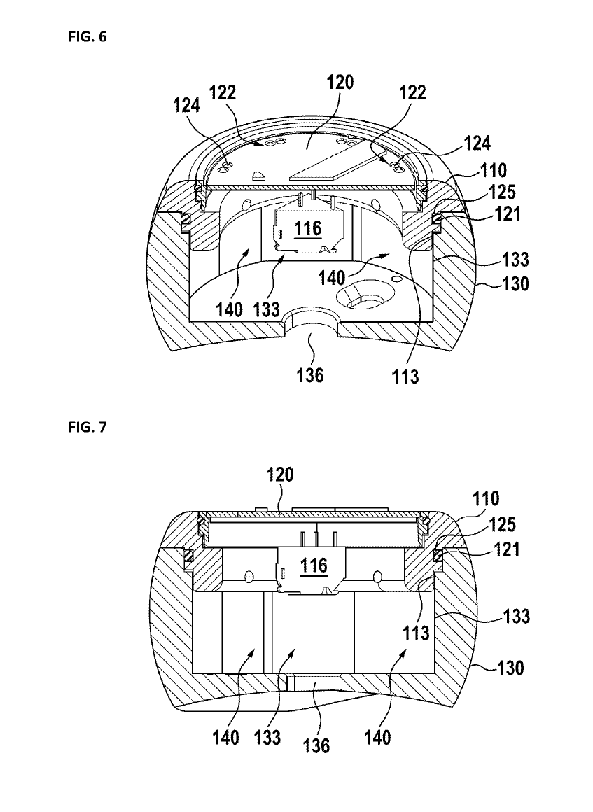

In FIG. 6 the signal requesting device 100 is shown in a fully assembled state. The first locking device 113 at the top cover 110 and the second locking device 133 at the housing base 130 engaging each other. Thus, the top cover 110 is not turnable against the housing base 130.

In FIG. 7, another view at the signal requesting device 100 of FIG. 6 is shown.

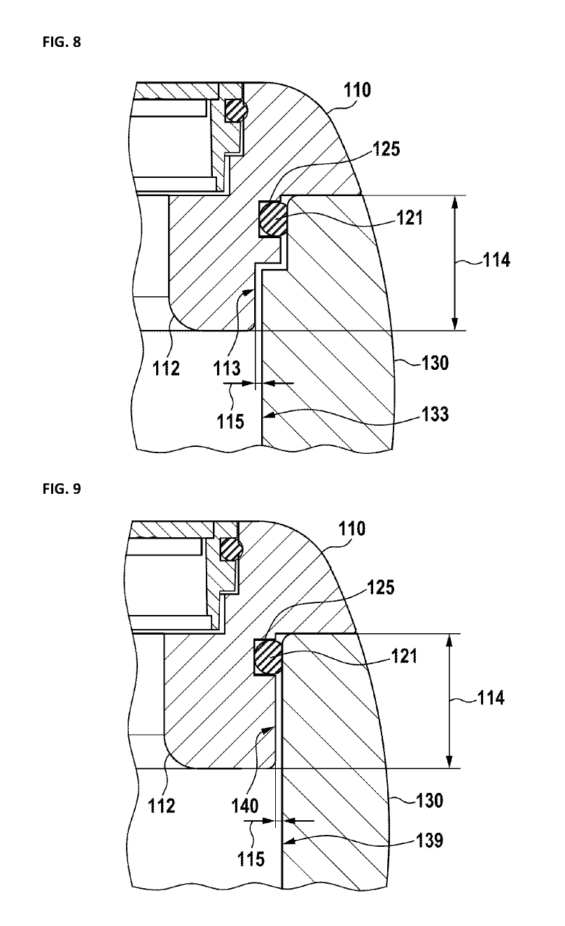

In FIG. 8, a detail view of the gap 115 and the depth of overlapping 114 between the top cover 110 and the housing base 130 is shown. The aforementioned fit system between the top cover 110 and the housing base 130 is defined by the ratio between a first value and a second value. The first value is defined by the depth of overlapping 114 between the insert ring 112 and the housing base 130. The second value is defined by the distance of a gap 115 between the insert ring 112 and the inner side of the housing base 115. The depth of overlapping 114 is defined as the depth the insert ring 112 protruding into the opening 134 of the housing base 130. The technical effect of the fit is, that the top cover 110 cannot be tilted out of the housing base 130. To open the housing 110, 130 the top cover 110 has to be removed from the housing base 130 by straight pulling. Tilting or rotating to support removal is not possible. Diagonally initiated force leads to cant during removing and the top cover 110 cannot be removed. The first locking device 113 at the top cover 110 and the second locking device 133 at the housing base 130 are engaging with each other. Thus, the top cover 110 is not turnable against the housing base 130.

FIG. 9, shows another detailed view of a cutting plane at a position where the outer surface 140 of the insert ring 112 has no first locking device 113 and the inner surface 139 of the housing base 130 has no second locking device 133.

It will be appreciated to those skilled in the art having the benefit of this disclosure that this invention is believed to provide signal requesting device. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

100 signal requesting device
110 top cover
111 opening
112 insert ring
113 first locking device
114 depth of overlapping
115 gap
116 connection terminal
120 switch module
121 seal
122 signaling device
123 arrow
124 LEDs
125 groove
130 housing base
131 bore
132 locking screw
133 second locking device
134 opening
135 opening diameter
136 fixation holes
137 recess
138 threaded hole
139 inner surface
140 outer surface
200 pole

1. A signal requesting device for traffic lights, said device comprising a switch module and a housing;
the housing including a housing base and a top cover, the top cover having an outer side and an inner side;
the top cover containing (i) an opening configured to accommodate the switch module therein, and (ii) an insert ring having a circular outer contour and protruding from the inner side of the top cover;
the housing base comprising a circular opening with an opening diameter dimensioned such that the insert ring fits tightly into said circular opening;
wherein
the insert ring has at least one first locking device,
the housing base has at least one second locking device at an inner side of said circular opening, said at least one second locking device being operably engaged with the at least one first locking device and configured to prevent relative rotation between the top cover and the housing base, and
wherein
a ratio of a first value, defined by a depth of a spatial overlap between the insert ring and the housing base, and a second value, defined by a width of a gap between the insert ring and the inner side of the housing base, is larger than 1.

2. The signal requesting device according to claim 1, wherein the top cover and the housing base are configured to be locked together by a locking screw.

3. The signal requesting device according to claim 2, wherein the insert ring has at least one recess with a threaded hole configured for holding the locking screw.

4. The signal requesting device according to claim 1, wherein the at least one first locking device comprises a first flat area at the outer side of the insert ring and at least one second locking device comprises a corresponding second flat area at the inner side of the opening of the housing base.

5. The signal requesting device according to claim 1, wherein multiple first locking devices at the inner side of the opening of the housing base are arranged at 90° with respect to each other.

6. The signal requesting device according to claim 1, wherein multiple second locking devices at the inner side of the opening of the housing base are arranged at 90° with respect to each other.

7. (canceled)

8. The signal requesting device according to claim wherein the ratio of the first value and the second value is larger than 10.

9. The signal requesting device according to claim 1, wherein the insert ring has a circumferential groove configured to accommodate a seal therein.

10. The signal requesting device according to claim 1, wherein the switch module is configured to detect presence of an object or a person, and to generate a trigger signal in response to having detected said presence.

11. The signal requesting device according to claim 1, wherein the switch module comprises at least two LEDs located adjacent to each other and controlled by the switch module.

12. The signal requesting device according to claim 11, wherein the switch module is configured to normally activate a first LED and to switch over to a second LED when the presence of an object or a person is detected.

13. A signal requesting device for traffic lights, said device comprising a switch module and a housing;
the housing including a housing base and a top cover, the top cover having an outer side and an inner side;
the top cover containing (i) an opening configured to accommodate the switch module therein, and (ii) an insert ring having a circular outer contour and protruding from the inner side of the top cover;
the housing base comprising a circular opening with an opening diameter dimensioned such that the insert ring fits tightly into said circular opening;
wherein the insert ring has at least one first locking device,
wherein the housing base has at least one second locking device at an inner side of said circular opening, said at least one second locking device being operably engaged with the at least one first locking device and configured to prevent relative rotation between the top cover and the housing base, and
wherein the switch module is configured to detect presence of an object or a person, and to generate a trigger signal in response to having detected said presence.

14. The signal requesting device according to claim 13, wherein the top cover and the housing base are configured to be locked together by a locking screw.

15. The signal requesting device according to claim 13, wherein the at least one first locking device comprises a first flat area at the outer side of the insert ring and at least one second locking device comprises a corresponding second flat area at the inner side of the opening of the housing base.

16. The signal requesting device according to claim 13, wherein at least one of (i) multiple first locking devices at the inner side of the opening of the housing base, and (ii) multiple second locking devices at the inner side of the opening of the housing base are arranged at 90° with respect to each other.

17. The signal requesting device according to claim 13, wherein a ratio of a first value, defined by a depth of a spatial overlap between the insert ring and the housing base and a second value, defined by a width of a gap between the insert ring and the inner side of the housing base, is larger than 1.

18. A signal requesting device for traffic lights, said device comprising a switch module and a housing;
the housing including a housing base and a top cover, the top cover having an outer side and an inner side;
the top cover containing (i) an opening configured to accommodate the switch module therein, and (ii) an insert ring having a circular outer contour and protruding from the inner side of the top cover;
the housing base comprising a circular opening with an opening diameter dimensioned such that the insert ring fits tightly into said circular opening;
wherein the insert ring has at least one first locking device,
wherein the housing base has at least one second locking device at an inner side of said circular opening, said at least one second locking device being operably engaged with the at least one first locking device and configured to prevent relative rotation between the top cover and the housing base, and
wherein the switch module comprises at least two LEDs located adjacent to each other and controlled by the switch module.

19. The signal requesting device according to claim 18, wherein the switch module is configured to normally activate a first LED and to switch over to a second LED when the presence of an object or a person is detected.

20. The signal requesting device according to claim 18, wherein the switch module is configured to detect presence of an object or a person, and to generate a trigger signal in response to having detected said presence.
